(19) United States
(12) Patent Application Publication
(10) Pub. No.: US 2015/0026648 A1
(43) Pub. Date: Jan. 22, 2015

(54) METHOD FOR TRIGGERING APPLICATIONS WITH A SMART DEVICE

(71) Applicant: bYAPPY Digital Media Group Ltd., Taipei City (TW)

(72) Inventors: HSIANG-TIEN WU, Hsinchu City (TW); Chris Yu, Taipei City (TW); Han Lin Lu, Hsinchu City (TW); Meng-Chen Shen, Taichung City (TW)

(21) Appl. No.: 14/336,293

(22) Filed: Jul. 21, 2014

Related U.S. Application Data
(60) Provisional application No. 61/857,022, filed on Jul. 22, 2013.

(51) Int. Cl. G06F 3/0484; G06F 3/0488; G06F 3/0481

(52) U.S. Cl. CPC G06F 3/0484; G06F 3/04817; G06F 3/0488
USPC 715/863

(57) ABSTRACT

A method of triggering applications on smart phone devices is provided, and the method triggers the smart device in particular way to activate at least one application based on a screen brightness variation of the smart device, wherein the triggering method may be performed by clicking, shaking or a distance sensing.

### FIELD OF THE INVENTION

The present invention relates to a triggering method of applications, and more particularly, to a method for triggering applications on smart phone devices based on a screen brightness variation thereof.

### RELATED ART

When it comes to triggering a mobile application with a smart device, there are several ways to achieve the goal. One of the ways is to make use of a Graphical User Interface (GUI) system. With regard to users, triggering an application through a GUI system saves time in memorizing instructions, however, if use installs too many applications on a smart device, it takes a certain time to search and click the specific application's icon to active this application. Furthermore, after the application is set up according to user preferences, it is necessary to re-activate the application for executing user preferences, instead of activating the application by any other triggering methods.

Another way for triggering is through a power key (hot key) of a smart device, allowing users less searching work for a particular icon among the application programs by just clicking on the key. However, such way requires a tangible hot key on smart devices.

Besides, when the smart device has been locked by a particular code, it takes a while to unlock for activating application.

### SUMMARY

A method of triggering applications of a smart device is provided, and the method triggers the smart device in particular way to activate at least one application based on a screen brightness variation of the smart device

The present invention provides a method for triggering applications of a smart device, wherein the smart device comprises a processing unit, and the processing unit determines whether a screen of the smart device have a brightness variation, so as to trigger at least one application on the smart device. In addition, if the processing unit determines the screen brightness variation is generated, it further imports a program parameter to trigger at least one application of the smart device.

In one embodiment, the screen brightness variation of the smart device is triggered by clicking.

In one embodiment, the clicking includes reaching a predetermined number of clicks in a predetermined period.

In one embodiment, the clicking is to click at least twice on any one of a power key or a hot key of the smart device; or to click at least once each on the power key and the hot key of the smart device

In one embodiment, the clicking is a double-clicking.

In one embodiment, the double-clicking is to click twice on any one of the power key or the hot key of the smart device; or to click once each on the power key and the hot key of the smart device.

In one embodiment, the smart device may be a cell phone, a tablet PC, a notebook PC, a desktop PC, a cloud PC or other smart devices.

In one embodiment, the application program may be a virtual phone application program. Moreover, in the field of future mobile communication, mobile communication application programs may allow users to set up at least one hotline to each other, and when a cell phone is under standby state, the hotline may be activated instantly, the unlock process will be skipped and the application program will be activated directly, so as to reduce the steps of unlocking the cell phone, and to improve the convenience of activating application programs. Besides, in the embodiment, the present invention may lock the cell phone automatically to secure user security. The mobile communication application programs may be Line, WeChat, Skype, Viber, Facebook etc. In addition, in the embodiment, the present invention can be widely applied to mobile communication in the future, which is not limited in mobile applications, any other smart devices are also compatible, for example, community application programs such as Twitter and Facebook etc., which allow users to update latest status, and the embodiment also applies to those applications. The embodiment activates these application programs instantly, and the application programs can be activated instantly even without entering unlocking process. In addition, the embodiment allows users to update the user information instantly and return to be locked after updating is done, so as to secure user security of the smart device.

Besides, in one embodiment, in the step of activating an application program, an executing message is displayed on the screen of the smart device in a preset time.

In one embodiment, in the step of displaying an executing message on the screen, it further includes displaying a preset image on the screen

In one embodiment, in the step of displaying an executing message on the screen, it further includes displaying a program option on the screen

In one embodiment, in the step of previously downloading the application program to a storage unit, it further includes: providing a time menu for choosing an interval period between triggering application programs and displaying the executing message on the screen; and providing a program option menu to choose a preset image displayed by the executing message.

In one embodiment, after an application program is activated, the smart device returns to standby state.

The previous description of the preferred embodiment is provided to further describe the present invention, not intended to limit the present invention. Any modification apparent to those skilled in the art according to the disclosure within the scope will be construed as being included in the present invention.

### BRIEF DESCRIPTION OF THE DRAWINGS

FIG. 1 is a flow chart according to the present invention;

FIG. 2 is a flow chart according to the present invention;

FIG. 3 is a block diagram of a smart phone according to the present invention;

FIG. 4 is a diagram of a menu interface according to the present invention;

FIG. 5 is a calling message displayed on a screen according to the present invention.

### DETAILED DESCRIPTION

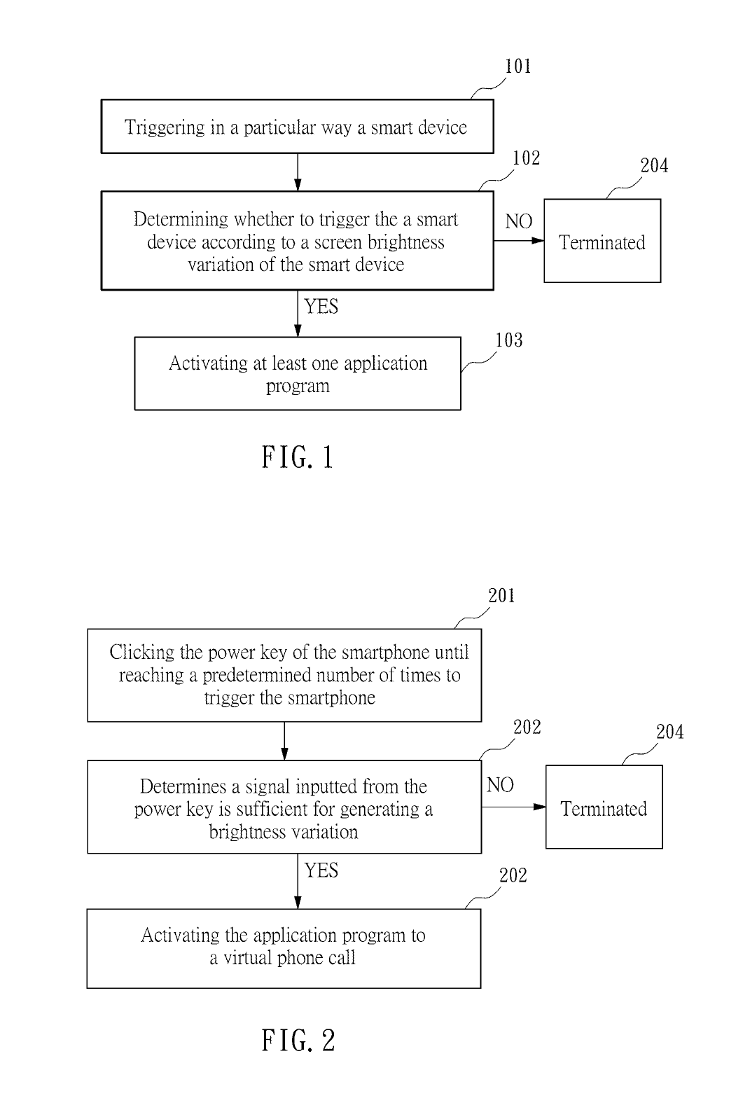

To understand the above feature and advantages of the present invention, reference will now be made in detail to the preferred embodiment of the present disclosure, examples of which are illustrated in the accompanying drawings. The accompanying drawings are simplified drawings schematically drawn for the purpose of describing basic structure of the present invention. FIG. 1 is a flow chart according to the present invention. FIG. 1 illustrates a flow chart of triggering application programs according to a screen brightness variation of a smart device, but the present invention is not limited thereto. The steps of FIG. 1 are described as following: first, triggering in a particular way a smart device (Step 101); determining whether to trigger the a smart device according to a screen brightness variation of the smart device (Step 102); if so, the smart device is triggered to activate at least one application program (Step 103); if not, the determining process will be terminated (Step 104).

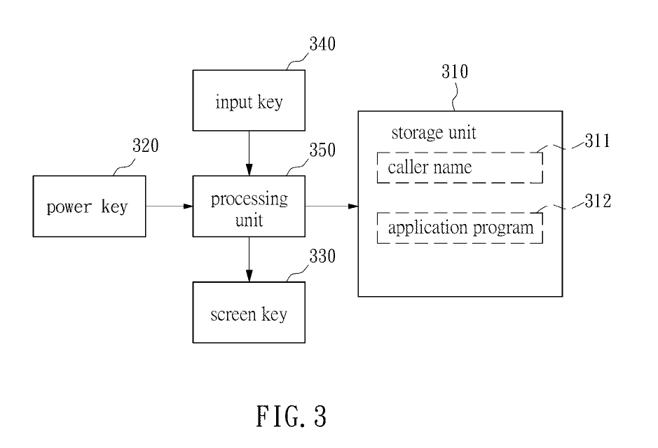

FIG. 2 is a flow chart according to the present invention. FIG. 2 illustrates a flow chart of triggering a virtual phone application program according to a screen brightness variation of a smartphone, but the present invention is not limited thereto. The steps of FIG. 2 are described as following: first, triggering a power key of the smartphone to generate an operating signal, that is, clicking the power key of the smartphone until reaching a predetermined number of times to trigger the smartphone (Step 201). In this case, please refer to FIG. 3, due to the present invention is mainly applied to smartphones, a smartphone may includes at least a storage unit 310, a hot key 320 (refers to a power key), a screen key 330, an input key 240 and a processing unit 350, the storage unit 310, the hot key 320, the screen key 330 and the input key 340 are electrically connects to the processing unit 350, the storage unit 310 is used for storing a caller name 311 (as shown in FIG. 3), and an application program 312 which is downloaded previously and stored in the storage unit.

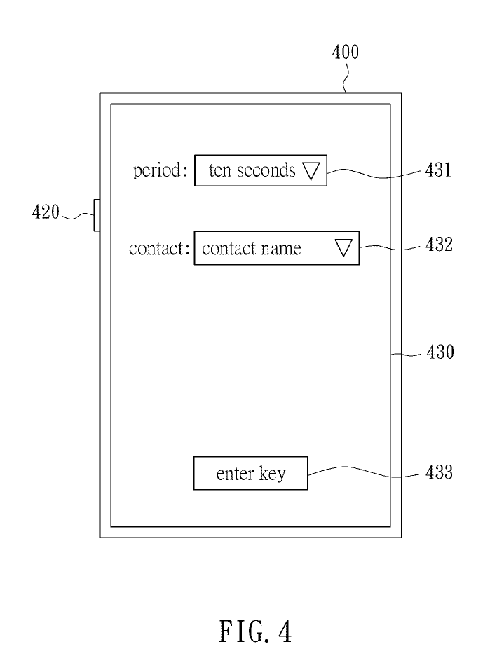

As shown in FIG. 4, after the application program is downloaded previously and stored in the storage unit, the step further comprises: providing a time menu 431 to, through the input unit 340, the user is provided with an option of triggering the application program, an interval time at which a calling information will be displayed on the screen and a contact information 432 to, through the input unit 340, choose a caller name shown by the calling information. Wherein, the contact information 432 further includes options of a smart phone contactors and a self-chosen one and enter key 433 is clicked after the options are taken.

After Step 201, please refer to FIG. 2, while reaching the predetermined number of times by continuously clicking the power key of the smartphone (Step 201), the processing unit determines a signal inputted from the power key is sufficient for generating a brightness variation (Step 202), and the predetermined number of clicking times may be twice. In an example that an interval period of double-clicking is less than a preset time, like in 1 second, the processing unit determines whether the interval period of double-clicking the power key is completed within 1 second. If it is completed within the preset time, the processing unit determines whether to generate a brightness variation (Step 202). If yes, the application program will be activated (Step 203) to a virtual phone call; if not, the determining process will be terminated (Step 204).

As general smartphones make use of the power key for switching the screen on and off, the present invention makes the screen of the smartphone flash (switch on and off) once or plenty of times in loop by pressing the power key for a preset number of times, and the processing unit triggers application programs according to whether the screen of the smartphone is flashed (switch on and off) once or plenty of times in loop.

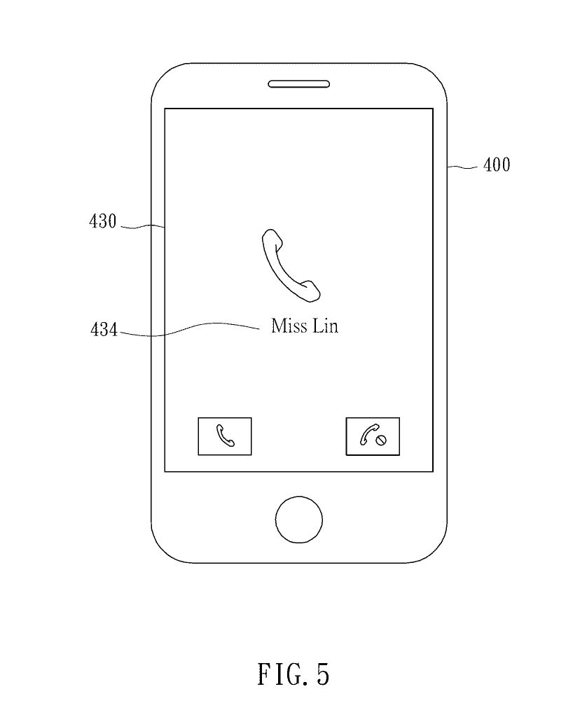

While completing the steps for configuring the setting and triggering the application program, a caller name 434 (shown in FIG. 5) will be displayed on the screen after the interval period of the application program chose in time menu is triggered.

In one embodiment, in the step of triggering the power key 420 for generating an operating signal, further including: determining whether a preset number of clicking is reached to have a screen brightness variation; and determining whether a period of the preset number of clicking is less than a predetermined period.

In one embodiment, in the step of the processing unit determines whether the screen flashes according to the operating signal is executed under a standby state of the smart device 400.

application programs of a smart device, in the present invention, application programs are triggered according to a screen brightness variation which is generated by clicking a certain key of the smart device through a particular pattern, wherein the smart device may be any one in this group: cell phones, tablet PCs, notebook PCs, desktop PCs, cloud PCs, and other smart devices. The embodiments mentioned above are illustrated by a virtual phone application program, and the present invention may be applied to other communication application software such as: Line, Skype, Viber, Facebook etc., moreover, the present invention may be widely extended to mobile communications, which is not limited to cell phones applications, and it can be used on any other smart devices, for example: community application programs such as Facebook and Twitter etc. The triggering method therein for application programs of the smart device may be clicking, shaking or sensing a distance variation between the smart device and a user. For example, the triggering method may be clicking twice or more on any one of the power key or the hotkey of the smart device, or clicking once or more each on the power key and the hotkey of the smart device. In addition, the clicking may be double-clicking, for example, clicking twice on any one of the power key or the hotkey of the smart device, or clicking once each on the power key and the hotkey of the smart device.

The previous description of the preferred embodiment is provided to further describe the present invention, not intended to limit the present invention. Any modification apparent to those skilled in the art according to the disclosure within the scope will be construed as being included in the present invention.

What is claimed is:

1. A method for triggering applications of a smart device, comprising:
triggering at least one application of the smart device based on a screen brightness variation of the smart device.

2. The method of claim 1, wherein the screen brightness variation of the smart device is triggered by clicking.

3. The method of claim 1, wherein the screen brightness variation of the smart device is triggered by a distance sensor based on a distance variation between the smart device and a user.

4. The method of claim 1, wherein the screen brightness variation of the smart device is triggered by shaking the smart device.

5. The method of claim 2, wherein the clicking function includes reaching a predetermined number of clicks in a predetermined period.

6. The method of claim 2, wherein the clicking function is a double-clicking.

7. The method of claim 6, wherein the double-clicking is to click twice on any one of a power key or a hot key of the smart device.

8. The method of claim 6, wherein the double-clicking is to click once each on a power key and a hot key of the smart device.

9. The method of claim 2, wherein the clicking function is to click at least twice on any one of a power key or a hot key of the smart device.

10. The method of claim 2, wherein the double-clicking function is to click at least once each on a power key and a hot key of the smart device.

11. The method of claim 1, wherein the smart device is a cell phone, a tablet, a notebook, a desktop, a cloud PC or other smart devices.

12. The method of claim 1, wherein the application is a virtual phone application.

13. The method of claim 12, wherein the virtual phone application displays an executing message on a screen of the smart device in a preset time.

14. The method of claim 12, wherein the virtual phone application displays a caller photo on a screen of the smart device.

15. The method of claim 1, wherein the application is a communication application or a community application.

16. The method of claim 15, wherein the communication application sets at least one hotline.

17. The method of claim 1, wherein the smart device further comprises determining whether a screen of the smart device has a brightness variation by a processing unit.

18. The method of claim 17, wherein when it is determined that the screen of the smart device has a brightness variation, importing a program parameter by the processing unit to trigger the smart device to activate at least one application.

19. The method of claim 17, wherein the screen brightness variation of the smart device is triggered by clicking.

20. The method of claim 19, wherein the clicking further comprises reaching a predetermined number of clicks in a predetermined period.

21. The method of claim 19, wherein the clicking function is a double-clicking.

22. The method of claim 21, wherein double-clicking function is to click twice on any one of a power key or a hot key of the smart device.

23. The method of claim 21, wherein the double-clicking function is to click once each on a power key and a hot key of the smart device.

24. The method of claim 19, wherein the clicking function is to click at least twice on any one of a power key or a hot key of the smart device.

25. The method of claim 19, wherein the double-clicking function is to click at least once each on a power key and a hot key of the smart device.

26. The method of claim 17, wherein the screen brightness variation of the smart device is triggered based on a distance variation sensed by a distance sensor between the smart device and a user.

27. The method of claim 17, wherein the screen brightness variation of the smart device is triggered by shaking the smart device.

28. The method of claim 17, wherein the smart device is a cell phone, a tablet, a notebook, a desktop, a cloud PC or other smart devices.

29. The method of claim 17, wherein the applications is a virtual phone application.

30. The method of claim 29, wherein the virtual phone application displays an executing message on the screen of the smart device in a preset time.

31. The method of claim 29, wherein the virtual phone application displays a caller photo on the screen.

32. The method of claim 17, wherein the application is a communication application or a community application.

33. The method of claim 32, wherein the communication application sets at least one hotline.
